(19) United States
(12) Patent Application Publication
(10) Pub. No.: US 2012/0282399 A1
(43) Pub. Date: Nov. 8, 2012

(54) Method of Manufacturing Fabric with Cool Effect

(76) Inventor: Jen-Huan Lu, Xinzhuang City (TW)

(21) Appl. No.: 13/102,088

(22) Filed: May 6, 2011

(51) Int. Cl. B05D 3/12; B05D 1/36

(52) U.S. Cl. 427/190; 427/201

(57) ABSTRACT

A method of manufacturing fabric includes the steps of grinding a material with cool effect into powder of nanometer scale; adding antibacterial zinc oxide powder of nanometer scale or antibacterial silver powder of nanometer scale to the powder; mixing the zinc oxide powder or the silver powder with the powder to form a mixture wherein weight percentages of the cool powder to either the zinc oxide powder or the silver powder are about 95 wt % to 5 wt %; and applying the mixture to top and bottom surfaces of a flat fiber assembly respectively so as to form a cool layer on each of the top and bottom surfaces of the flat fiber assembly.

### BACKGROUND OF THE INVENTION

1. Field of the Invention

The invention relates to fabric manufacturing and more particularly to a method of manufacturing fabric with cool effect so that a wearer may feel a degree of coolness when wearing clothes made of such fabric.

2. Description of Related Art

It is well known that some types of clothing are made of fabric having poor vapor permeability. In often times that a person wearing clothes made of such fabric may feel uncomfortable especially in hot summer days because perspiration cannot be carried away from the skin.

There are many so-called “breathable” clothes commercially available. However, a person wearing the clothes may not have the feeling of comfort as desired. Further, there is prior literature about “cool fabric” disclosed. Such fabric can be made by adding a material with cool effect to fibers, spinning the fibers into threads, and further, for example, weaving. However, its manufacturing process including the grinding of cool material and the addition of the material to the fibers is very complex and cost ineffective and further its quality is not as good as it desires. Thus, the need for improvement still exists.

### SUMMARY OF THE INVENTION

It is therefore one object of the invention to provide a method of manufacturing fabric comprising the steps of grinding a material with cool effect into powder of nanometer scale; adding antibacterial zinc oxide powder of nanometer scale or antibacterial silver powder of nanometer scale to the powder; mixing the zinc oxide powder or the silver powder with the powder to form a mixture wherein weight percentages of the cool powder to either the zinc oxide powder or the silver powder are about 95 wt % to 5 wt %; and applying the mixture to top and bottom surfaces of a flat fiber assembly respectively so as to form a cool layer on each of the top and bottom surfaces of the flat fiber assembly.

Whereby, a wearer may feel a degree of coolness due to the cool layers when wearing clothes made of the fabric of the invention. Moreover, the fabric has antibacterial effect due to the inclusion of zinc oxide powder of nanometer scale or silver powder of nanometer scale. Further, the method is easy to implement and mass production can be carried out with the manufacturing cost being greatly reduced.

The above and other objects, features and advantages of the invention will become apparent from the following detailed description taken with the accompanying drawings.

### BRIEF DESCRIPTION OF THE DRAWINGS

FIG. 1 is a flow chart diagram of a method of manufacturing fabric with cool effect according to the invention;

FIG. 2 is a perspective view of a piece of fabric made by the method of the invention;

FIG. 3 is a photograph of the fabric of FIG. 2 being magnified 600 times; and

FIG. 4 is a photograph of the fabric of FIG. 2 being magnified 3,000 times.

### DETAILED DESCRIPTION OF THE INVENTION

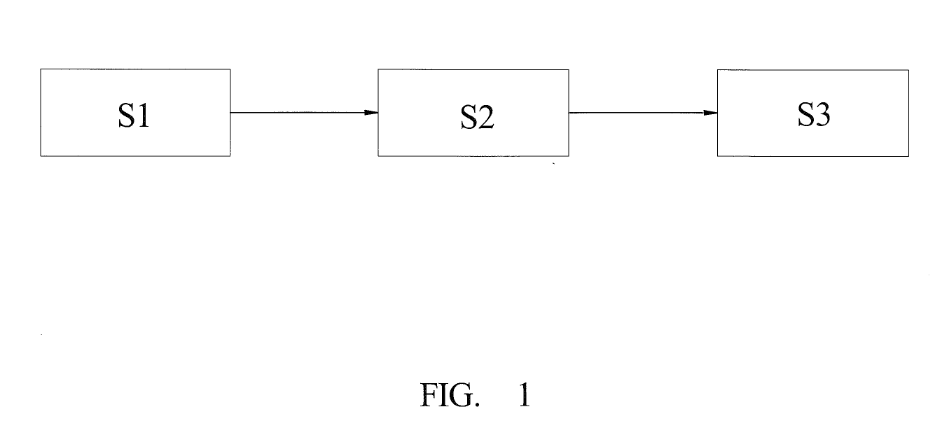

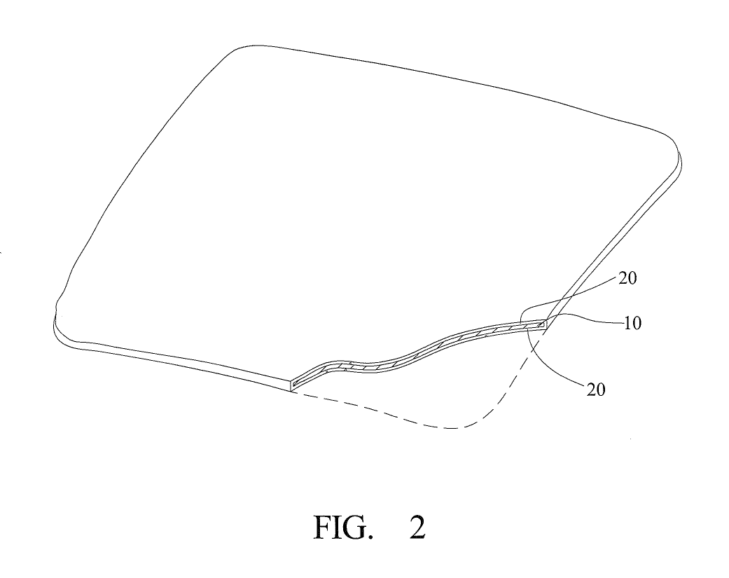

Referring to FIGS. 1 and 2, a method of manufacturing fabric with cool effect in accordance with the invention is illustrated below. The method comprises the following steps:

Step S1: Grinding mica, crystal, or jade material into powder of about 50-500 nm (i.e., nanometer scale). The powder is thus called cool powder. Composition (%) of each of mica, crystal, and jade materials is tabulated below.

TABLE 1
Composition (%) of mica material

| | |
|---|---|
| SiO₂ | 50.00% |
| Al₂O₃ | 34.00% |
| K₂O | 9.70% |
| Fe₂O₃ | 5.00% |
| Other components | 1.30% |

TABLE 2
Composition (%) of crystal material

| | |
|---|---|
| SiO₂ | 95.00% |
| Al₂O₃ | 0% |
| K₂O | 0% |
| Fe₂O₃ | 4.50% |
| Other components | 0.50% |

TABLE 3
Composition (%) of jade material

| | |
|---|---|
| SiO₂ | 51.00% |
| Al₂O₃ | 42.00% |
| K₂O | 0% |
| Fe₂O₃ | 0% |
| Other components | 7.00% |

Step 2: Adding zinc oxide powder of nanometer scale or silver powder of nanometer scale to the cool powder and mixing same to form a uniform mixture in which both the zinc oxide powder and the silver powder are antibacterial and weight percentages of the cool powder to either the zinc oxide powder or the silver powder are about 95 wt % to 5 wt %.

Step 3: Applying the mixture to top and bottom surfaces of a flat fiber assembly 10 respectively so as to form a cool layer 20 on each of the top and bottom surfaces of the fiber assembly 10.

The method of the invention can be further illustrated in the following three preferred embodiments:

### First Preferred Embodiment

Step 1: Grinding mica, crystal, or jade material into powder of about 50-500 nm (i.e., nanometer scale). The powder is thus called cool powder.

Step 2: Adding zinc oxide powder of nanometer scale or silver powder of nanometer scale to the cool powder and mixing same to form a uniform mixture in which both the zinc oxide powder and the silver powder are antibacterial and weight percentages of the cool powder to either the zinc oxide powder or the silver powder are about 95 wt % to 5 wt %.

Step 3: Adding a bridge agent PUR (polyurethane) to the mixture for further mixing prior to applying to both top and bottom surfaces of a flat fiber assembly 10 respectively so as to form a cool layer 20 on each of the top and bottom surfaces of the flat fiber assembly 10 in which the weight percentage of the bridge agent is about 1-2 wt % of the mixture.

### Second Preferred Embodiment

Step 1: Grinding mica, crystal, or jade material into powder of about 50-500 nm (i.e., nanometer scale). The powder is thus called cool powder.

Step 2: Adding zinc oxide powder of nanometer scale or silver powder of nanometer scale to the cool powder and mixing same to form a uniform mixture in which both the zinc oxide powder and the silver powder are antibacterial and weight percentages of the cool powder to either the zinc oxide powder or the silver powder are about 95 wt % to 5 wt %.

Step 3: Sequentially adding a foam agent and a bridge agent PUR (polyurethane) to the mixture for further mixing prior to applying to both top and bottom surfaces of a flat fiber assembly 10 respectively so as to form a cool layer 20 on each of the top and bottom surfaces of the flat fiber assembly 10 in which the weight percentage of the bridge agent is about 1-2 wt % of the mixture.

### Third Preferred Embodiment

Step 1: Grinding mica, crystal, or jade material into powder of about 50-500 nm (i.e., nanometer scale). The powder is thus called cool powder.

Step 2: Adding zinc oxide powder of nanometer scale or silver powder of nanometer scale to the cool powder and mixing same to form a uniform mixture in which both the zinc oxide powder and the silver powder are antibacterial and weight percentages of the cool powder to either the zinc oxide powder or the silver powder are about 95 wt % to 5 wt %.

Step 3: Dying the mixture, placing a flat fiber assembly 10 in the mixture for mixing, and pressing both top and bottom surfaces of the flat fiber assembly 10 respectively so as to form a cool layer 20 on each of the top and bottom surfaces of the flat fiber assembly 10.

The provision of the bridge agent facilitates adherence of silicon dioxide (SiO₂) and aluminum oxide (Al₂O₃) (alumina) in the mixture to the flat fiber assembly 10. Further, silicon dioxide and alumina of nanometer scale facilitate adherence themselves to the flat fiber assembly 10.

The fabric of the invention has been tested by TTRI (Taiwan Textile Research Institute) and its excellent water absorbency, breathability, and coolness feeling are best demonstrated in the following tables 4 to 7:

TABLE 4

| | |
|---|---|
| Test Items | Touch feeling of warmth or coolness |
| | Q-max(W/cm²) (Knitted fabric) |
| Test results | 0.086 |
| Test methods | KES-F7 Thermo Labo II |
| Sample description | GC-2A077 100% POLY MINI EYELET PK |

TABLE 5

| | |
|---|---|
| Test Items | Touch feeling of warmth or coolness |
| | Q-max(W/cm²) (Knitted fabric) |
| Test results | 0.113 |
| Test methods | KES-F7 Thermo Labo II |
| Sample description | GC-2A077-SCT 100% POLY MINI EYELET |
| | PK FINISH: STONE DYE |

TABLE 6

| | |
|---|---|
| Test Items | Touch feeling of warmth or coolness |
| | Q-max(W/cm²) (Woven fabric) |
| Test results | 0.159 |
| Test methods | KES-F7 Thermo Labo II |
| Sample description | GTP-A017W 100% POLY DOBBY |

TABLE 7

| | |
|---|---|
| Test Items | Touch feeling of warmth or coolness |
| | Q-max(W/cm²) (Woven fabric) |
| Test results | 0.171 |
| Test methods | KES-F7 Thermo Labo II |
| Sample description | GTP-A017W-SCT 100% POLY DOBBY WITH |
| | STONE COLD DYE FINISH |

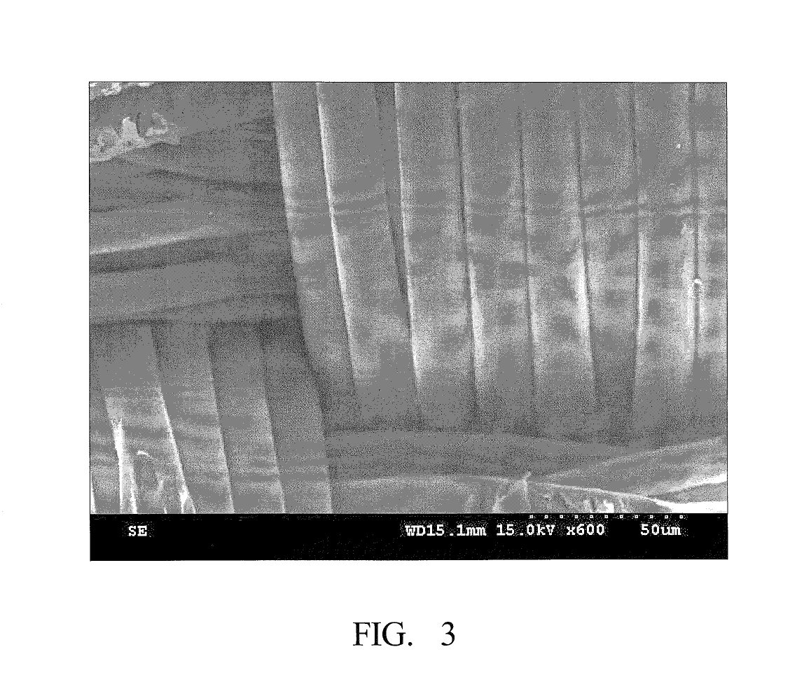

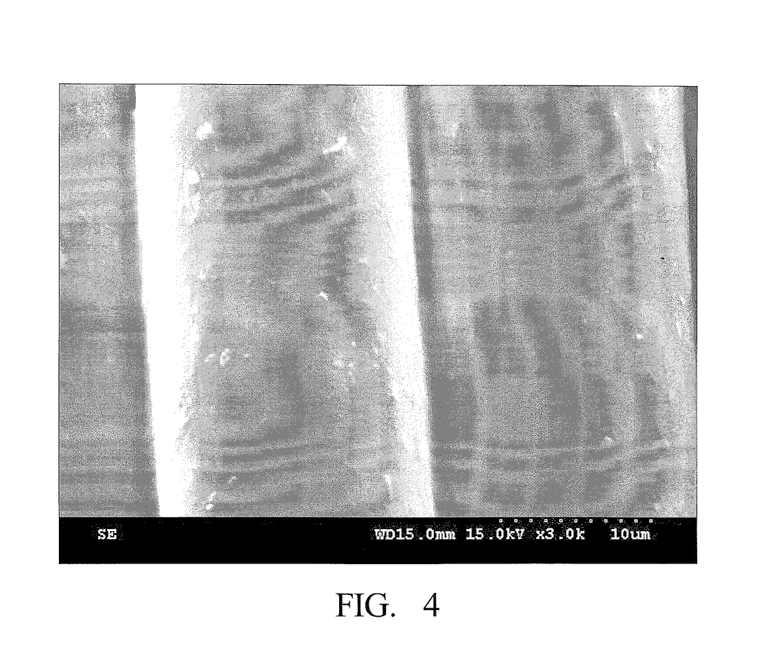

Referring to FIGS. 3 and 4, two photographs of the fabric of the invention are magnified 600 times and 3,000 times respectively. It is envisaged by the invention that a wearer may feel a degree of coolness when wearing clothes made of the fabric. Moreover, the fabric has antibacterial effect due to the inclusion of zinc oxide powder of nanometer scale or silver powder of nanometer scale. Further, the method is easy to implement and mass production can be carried out with the manufacturing cost being greatly reduced.

While the invention has been described in terms of preferred embodiments, those skilled in the art will recognize that the invention can be practiced with modifications within the spirit and scope of the appended claims.

What is claimed is:

1. A method of manufacturing fabric comprising the steps of:
grinding mica, crystal, or jade material into powder of nanometer scale;
adding antibacterial zinc oxide powder of nanometer scale or antibacterial silver powder of nanometer scale to the powder;
mixing the zinc oxide powder or the silver powder with the powder to form a mixture wherein weight percentages of the cool powder to either the zinc oxide powder or the silver powder are about 95 wt % to 5 wt %; and
applying the mixture to top and bottom surfaces of a flat fiber assembly respectively so as to form a cool layer on each of the top and bottom surfaces of the flat fiber assembly.

2. The method of claim 1, wherein size of the powder is of about 50-500 nm.

3. The method of claim 1, wherein the mica having about 50% silicon dioxide (SiO₂) and about 34% aluminum oxide (Al₂O₃).

4. The method of claim 1, wherein the crystal having about 95% silicon dioxide (SiO₂).

5. The method of claim 1, wherein the jade having about 51% silicon dioxide (SiO₂) and about 42% aluminum oxide (Al₂O₃).

6. The method of claim 1, further comprising adding a bridge agent to the mixture for further mixing prior to application step, wherein application step comprises applying the mixture to both top and bottom surfaces of the flat fiber assembly respectively so as to form a cool layer on each of the top and bottom surfaces of the fiber assembly, and wherein weight percentage of the bridge agent is about 1-2 wt % of the mixture.

7. The method of claim 6, wherein the bridge agent is PUR (polyurethane).

8. The method of claim 1, further comprising sequentially adding a foam agent and a bridge agent to the mixture for further mixing prior to application step, wherein application step comprises applying the mixture to both top and bottom surfaces of the flat fiber assembly respectively so as to form a cool layer on each of the top and bottom surfaces of the fiber assembly, and wherein weight percentage of the bridge agent is about 1-2 wt % of the mixture.

9. The method of claim 8, wherein the bridge agent is PUR (polyurethane).

10. The method of claim 1, further comprising dying the mixture, placing a flat fiber assembly in the mixture for mixing, and pressing both top and bottom surfaces of the flat fiber assembly respectively so as to form a cool layer on each of the top and bottom surfaces of the flat fiber assembly.
